(19) United States
(12) Patent Application Publication
(10) Pub. No.: US 2023/0378609 A1
(43) Pub. Date: Nov. 23, 2023

(54) LITHIUM-ION BATTERY WITH HIGH ENERGY DENSITY

(71) Applicant: GM GLOBAL TECHNOLOGY OPERATIONS LLC, Detroit, MI (US)

(72) Inventors: Sherman H. Zeng, Troy, MI (US); Xingcheng Xiao, Troy, MI (US)

(73) Assignee: GM GLOBAL TECHNOLOGY OPERATIONS LLC, Detroit, MI (US)

(21) Appl. No.: 17/750,773

(22) Filed: May 23, 2022

(51) Int. Cl. H01M 50/457; H01M 50/434

(52) U.S. Cl. CPC H01M 50/457; H01M 50/434; H01M 2220/20

(57) ABSTRACT

A system including a lithium-ion battery is provided. The system includes two electrodes, which include an anode and a cathode. The system further includes an electrolyte and a planar separator disposed between the anode and the cathode. The planar separator includes a first planar face, a second planar face, a layer of porous ceramic material coating the first planar face, and lithium deposited upon the layer of porous ceramic material. The lithium is in contact with one of the two electrodes.

### INTRODUCTION

The disclosure generally relates to a lithium-ion battery with high energy density.

A lithium-ion battery includes an anode, a cathode, a separator, and an electrolyte. A battery may operate in charge mode, receiving electrical energy. A battery may operate in discharge mode, providing electrical energy. A battery may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

### SUMMARY

A system including a lithium-ion battery is provided. The system includes two electrodes, which include an anode and a cathode. The system further includes an electrolyte and a planar separator disposed between the anode and the cathode. The planar separator includes a first planar face, a second planar face, a layer of porous ceramic material coating the first planar face, and lithium deposited upon the layer of porous ceramic material. The lithium is in contact with one of the two electrodes.

In some embodiments, the layer of porous ceramic material includes a first layer of porous ceramic material. The planar separator further includes a second layer of porous ceramic material coating the second planar face.

In some embodiments, the first layer of porous ceramic material is formed from a first material selected from the group consisting of zeolite, alumina, silica, titania, zirconia, and combinations thereof. The second layer of porous ceramic material formed from a second material selected from the group consisting of zeolite, alumina, silica, titania, zirconia, and combinations thereof.

In some embodiments, the lithium deposited upon the layer of porous ceramic material is a first layer of lithium. The planar separator further includes a second layer of lithium deposited upon the second layer of porous ceramic material.

In some embodiments, the layer of porous ceramic material is formed from a material selected from the group consisting of zeolite, alumina, silica, titania, zirconia, and combinations thereof.

In some embodiments, the lithium deposited upon the layer of porous ceramic material is a layer of lithium.

In some embodiments, the lithium is in contact with the anode.

In some embodiments, the lithium is in contact with the cathode.

According to one alternative embodiment, a system is provided. The system includes a device including a lithium-ion battery. The lithium-ion battery includes two electrodes including an anode and a cathode. The lithium-ion battery further includes an electrolyte and a planar separator disposed between the anode and the cathode. The planar separator includes a first planar face, a second planar face, a layer of porous ceramic material coating the first planar face, and lithium deposited upon the layer of porous ceramic material. The lithium is in contact with one of the two electrodes.

In some embodiments, the device includes a vehicle.

In some embodiments, the layer of porous ceramic material includes a first layer of porous ceramic material. The planar separator further includes a second layer of porous ceramic material coating the second planar face.

In some embodiments, the first layer of porous ceramic material is formed with a first material selected from a group consisting of zeolite, alumina, silica, titania, zirconia, and a mixture thereof. The second layer of porous ceramic material formed with a second material selected from the group consisting of zeolite, alumina, silica, titania, zirconia, and a mixture thereof.

In some embodiments, the layer of porous ceramic material is formed with a material selected from a group consisting of zeolite, alumina, silica, titania, zirconia, and a mixture thereof.

In some embodiments, the first layer of porous ceramic material is formed from a first material selected from the group consisting of zeolite, alumina, silica, titania, zirconia, and combinations thereof. The second layer of porous ceramic material formed from a second material selected from the group consisting of zeolite, alumina, silica, titania, zirconia, and combinations thereof.

In some embodiments, the layer of porous ceramic material is formed from a material selected from a group consisting of zeolite, alumina, silica, titania, zirconia, and combinations thereof.

In some embodiments, the lithium deposited upon the layer of porous ceramic material is a layer of lithium.

In some embodiments, the lithium is in contact with the anode.

In some embodiments, the lithium is in contact with the cathode.

According to one alternative embodiment, a lithium-ion battery system is provided. The system includes an alternating electrode pattern including a plurality of anodes and a plurality of cathodes. The system further includes an electrolyte and a plurality of planar separators each disposed between each of the plurality of anodes and each of the plurality of cathodes. Each of the plurality of planar separators includes a first planar face, a second planar face, a first layer of porous ceramic material coating the first planar face, and a second layer of porous ceramic material coating the second planar face. Each of a portion of the plurality of planar separators further includes a layer of lithium deposited upon the first layer of porous ceramic material. The layer of lithium is in contact with one of the plurality of anodes and one of the plurality of cathodes.

In some embodiments, each of the plurality of planar separators further includes the layer of lithium deposited upon the first layer of porous material.

In some embodiments, the layer of lithium includes a first layer of lithium, and each of the portion of the plurality of planar separators further includes a second layer of lithium deposited upon the second layer of porous ceramic material.

In some embodiments, each of a remaining portion of the plurality of planar separators is lithium-layer-free, and the portion of the planar separators and the remaining portion of the planar separators form an alternating pattern within the lithium-ion battery system.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in cross-sectional view an exemplary lithium-ion battery including a planar separator coated on both sides of the separator with layers of porous ceramic material and including lithium deposited upon on one of the layers of porous ceramic material, in accordance with the present disclosure;

FIG. 2 schematically illustrates in cross-sectional view one embodiment of the lithium-ion battery of FIG. 1, including a visible, substantially uniform layer of lithium upon a side of the layer of porous ceramic material facing the anode, in accordance with the present disclosure;

FIG. 3 schematically illustrates in cross-sectional view an alternative embodiment of the lithium-ion battery of FIG. 1, including a visible, substantially uniform layer of lithium upon a side of the layer of porous ceramic material facing the cathode, in accordance with the present disclosure;

FIG. 4 schematically illustrates in cross-sectional view an alternative embodiment of the lithium-ion battery of FIG. 1, including a first visible, substantially uniform layer of lithium upon a side of the layer of porous ceramic material facing the anode and a second visible, substantially uniform layer of lithium upon a side of the layer of porous ceramic material facing the cathode, in accordance with the present disclosure;

FIG. 5 schematically illustrates an exemplary device including a vehicle, wherein the device includes a plurality of the lithium-ion batteries of FIG. 1 configured collectively as a battery system, in accordance with the present disclosure;

FIG. 6 is a flowchart illustrating an exemplary method to form a lithium-ion battery including a planar separator coated on both sides of a separator with layers of porous ceramic material and including lithium deposited upon on one of the layers of porous ceramic material, in accordance with the present disclosure;

FIG. 7 illustrates an exemplary battery system including an alternating stack of anodes and cathodes, wherein separators are illustrated disposed between each of the electrodes and wherein every other separator includes layers of lithium disposed on both sides of the separator, in accordance with the present disclosure; and

FIG. 8 illustrates an alternative battery system including an alternating stack of anodes and cathodes, wherein separators are illustrated disposed between each of the electrodes and wherein every separator has a single layer of lithium disposed facing a same side of the battery system, in accordance with the present disclosure.

### DETAILED DESCRIPTION

A lithium-ion battery is configured for use in discharging cycles, wherein chemical energy is transformed into electrical energy which is provided for use by an attached system, and charging cycles, wherein electrical energy is provided to the lithium-ion battery and stored therein as chemical energy. During a discharge cycle, lithium ions move from the anode, through the separator, and return back to a molecular structure of the cathode. During a charging cycle, lithium ions move out from the cathode, through the separator, and intercalate into the anode. The process of lithium ions moving back and forward between the anode and the cathode during the discharge cycle is relatively efficient, with almost all of the lithium ions that leave the anode reaching and returning back to the cathode. The process of lithium ions moving and being intercalated into the anode during the charging cycle is less efficient than the process during the discharge cycle, with lithium ions being lost to formation of a solid electrolyte interphase (SEI) layer upon the anode and other unintended chemical reactions. A battery with a deficient amount of lithium, such as may be created by loss of lithium during charging cycles, may exhibit decreased performance and reduced battery life.

Pre-lithiation is a process whereby an excess amount of lithium is provided or formed within the battery in anticipation of offsetting lithium lost to charging cycles. By providing excess lithium within the battery, excellent performance and useful life of the battery may be realized. Effectiveness of the excess lithium within the battery varies based upon where the excess lithium is deposited. The excess lithium may not participate in lithium-ion transfer if the excess lithium is not in contact with either the anode or the electrode. Further, battery cell formation or assembly may be complicated based upon the excess lithium. A pre-lithiated anode or pre-lithiated cathode may be difficult to handle and store. Lithium foil may be difficult to handle and may include long formation cycles.

A system including a lithium-ion battery with high energy density and a method for forming the lithium-ion battery are provided. The lithium-ion battery includes a planar separator including a layer of porous ceramic material coating at least one side of the planar separator. The lithium-ion battery may include the two layers of the porous ceramic material, one coating each of two planar faces of the planar separator. The layer of porous ceramic material may be formed with zeolite, alumina, silica, titania, zirconia, and combinations thereof. Lithium may be deposited upon the layer of porous ceramic material. The layer of porous ceramic material including the deposit of lithium may be in contact with or facing an anode of the lithium-ion battery. The layer of porous ceramic material including the deposit of lithium may be in contact with or facing a cathode of the lithium-ion battery.

The layer of porous ceramic material is porous to enable saturation of the porous ceramic material with an electrolyte of the lithium-ion battery, such that lithium-ions may pass through the porous ceramic material. Lithium may be deposited upon the layer of porous ceramic material to prevent the deposited lithium from being formed directly upon the separator. Lithium deposited directly upon the separator may clog pores in the separator and interfere with the free transfer of lithium-ions through the separator.

The layer of porous ceramic material including the lithium deposited upon the layer may be in contact with either the anode or the cathode of the lithium-ion battery. By placing the deposited lithium in contact with one of the electrodes, the lithium receives a same electric potential as the electrode, such that lithium-ion transfer from the lithium deposited upon the layer of porous ceramic material takes place as a normal part of charging cycles and discharging cycles of the lithium-ion battery.

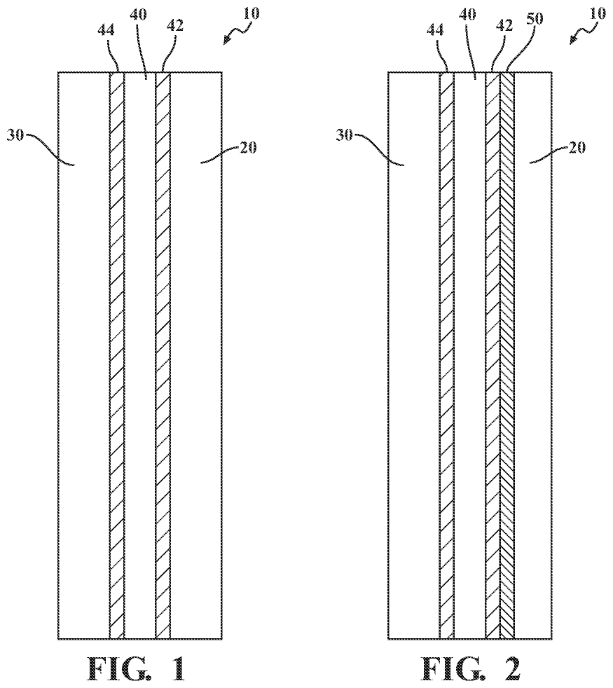

Referring now to the drawings, wherein like reference numbers refer to like features throughout the several views, FIG. 1 schematically illustrates in cross-sectional view an exemplary lithium-ion battery 10 including a planar separator 40 coated on both sides of the separator 40 with layers of porous ceramic material 42 and 44 and including lithium deposited upon on one of the layers of porous ceramic material 42 and 44. The lithium-ion battery 10 includes an anode 20, a cathode 30, and an electrolyte 60. The planar separator 40 includes a first planar face 41 on one side of the planar separator 40 and a second planar face 43 on a second side of the planar separator 40, with a substantially constant material thickness between the two planar faces 41 and 43. The planar separator 40 enables ion transfer through the planar separator 40 and may be formed with a polymerized material. The layers of porous ceramic material 42 and 44 may be formed with zeolite, alumina, silica, titania, zirconia, and combinations thereof.

FIG. 2 schematically illustrates in cross-sectional view one embodiment of the lithium-ion battery 10 of FIG. 1, including a visible, substantially uniform layer of lithium 50 upon a side of the layer of porous ceramic material 42 facing the anode 20. The components of the lithium-ion battery 10 are illustrated in layers with similar thicknesses for purposes of clear illustration. It will be appreciated that the actual thicknesses of the layers may vary, for example, with the layer of lithium 50 being measurable in microns of thickness in some embodiments. The layer of lithium 50 is in contact with the anode 20, such that an electric charge of the anode 20 is provided to the layer of lithium 50. In this way, lithium-ions are generated from the layer of lithium 50 during discharging cycles of the lithium-ion battery 10.

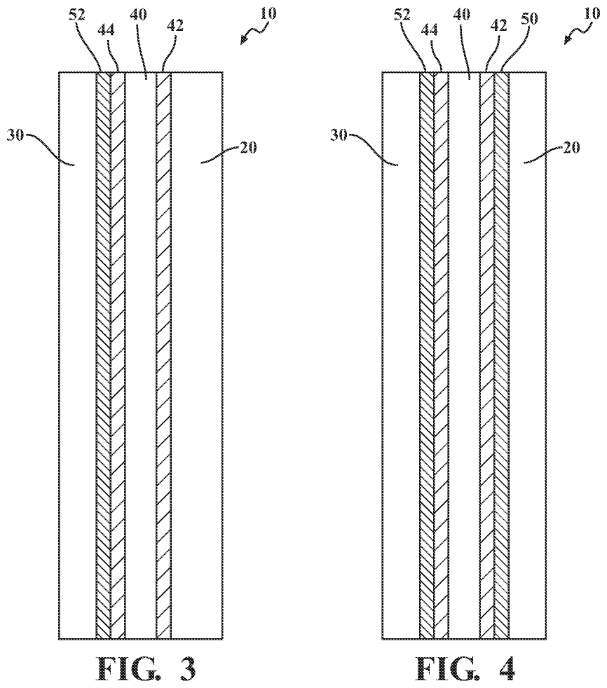

FIG. 3 schematically illustrates in cross-sectional view an alternative embodiment of the lithium-ion battery 10 of FIG. 1, including a visible, substantially uniform layer of lithium 52 upon a side of the layer of porous ceramic material 44 facing the cathode 30. The components of the lithium-ion battery 10 are illustrated in layers with similar thicknesses for purposes of clear illustration. It will be appreciated that the actual thicknesses of the layers may vary, for example, with the layer of lithium 52 being measurable in microns of thickness in some embodiments. The layer of lithium 52 is in contact with the cathode 30, such that an electric charge of the cathode 30 is provided to the layer of lithium 52. In this way, lithium-ions are generated from the layer of lithium 52 during charging cycles of the lithium-ion battery 10. In one alternative embodiment, the layer of lithium 52 of FIG. 3 may be deposited upon the cathode 30 instead of or in addition to being deposited upon the separator 40 or the layer of porous ceramic material 44.

The layers of lithium 50 and 52 described in FIGS. 2 and 3 can be either deposited onto a single side or both sides of the separator 40, depending on the battery design circumstances and the structure of the battery system. FIG. 4 schematically illustrates in cross-sectional view an alternative embodiment of the lithium-ion battery 10 of FIG. 1, including a first visible, substantially uniform layer of lithium 50 upon a side of the layer of porous ceramic material 42 facing the anode 20 and a second visible, substantially uniform layer of lithium 52 upon a side of the layer of porous ceramic material 44 facing the cathode 30. The separator 40 with the layers of porous ceramic material 42 and 44 is coated with lithium on one side of each of the layers of porous ceramic material 42 and 44. The lithium layer facing to the anode 20, i.e., layer of lithium 50, after cell assembly, will complete the pre-lithiation quickly, while lithium layer facing the cathode 30, i.e., layer of lithium 52, may take time to cross the separator 40 in order to reach the anode 20. This process may take multiple cycles to complete. In addition, the layers of lithium 52 facing to one of the cathodes 30 may serve as a lithium source to provide the battery system with an excellent lifespan. The configuration of FIG. 4 may reduce a total thickness of lithium layer coatings 50, 52, saving material as compared to the single side coating embodiments of FIGS. 2 and 3.

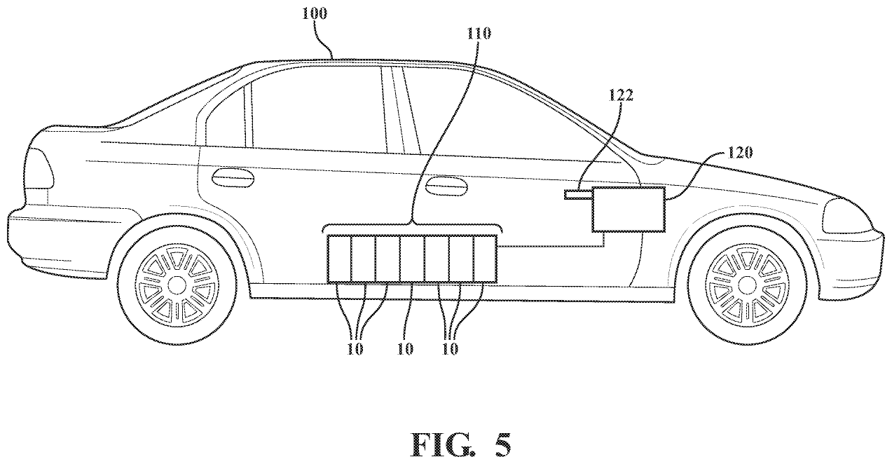

FIG. 5 schematically illustrates an exemplary device 100 including a vehicle, wherein the device 100 includes a plurality of the lithium-ion batteries 10 of FIG. 1 configured collectively as a battery system 110. The device 100 further includes an electric machine 120 including an output component 122 embodied as an output shaft configured for providing an output torque and/or receiving an input torque. The battery system 110 may provide electrical energy useful to operate and propel the device 100. Charging cycles of the batteries 10 may be accomplished by receiving or recovering electrical energy from a plurality of possible sources, such as but not limited to an electrical plug configured for receiving energy from an infrastructure device, a fuel cell, and utilizing regenerative braking for the device 100.

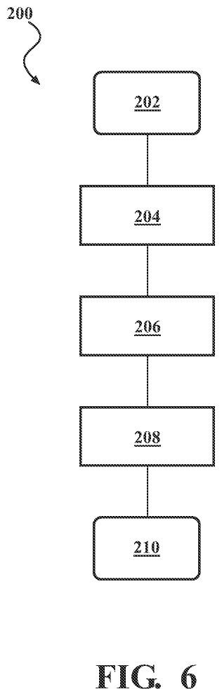

FIG. 6 is a flowchart illustrating an exemplary method 200 to form a lithium-ion battery 10 of FIG. 1 including a planar separator 40 of FIG. 1 coated on both sides of a separator 40 of FIG. 1 with layers of porous ceramic material 42, 44 of FIG. 1 and including lithium deposited upon on one of the layers of porous ceramic material 42, 44. The method 200 starts at step 202. At step 204, a polymerized planar separator 40 is coated on both sides with layers of porous ceramic material 42,44, wherein the porous ceramic material 42, 44 may include zeolite, alumina, silica, titania, zirconia, and combinations thereof. At step 206, a layer of lithium 50, 52 of FIGS. 2-4 is deposited upon one of the layers of porous ceramic material 42, 44 by deposition including thermal deposition, vapor deposition under vacuum, and chemical deposition. At step 208, the separator 40 including the layers of porous ceramic material 42, 44 and including the layer of lithium 50, 52 is installed to or is used to form a lithium-ion battery 10 by placing the separator 40 between an anode 20 and a cathode 30 of FIG. 1 and adding an electrolyte 60 of FIG. 1 which may include a liquid electrolyte composition. The method 200 ends at step 210. The method 200 is provided as an exemplary method for forming a lithium-ion battery 10. A number of alternative and/or additional method steps are envisioned, and the disclosure is not intended to be limited to the exemplary method steps provided herein.

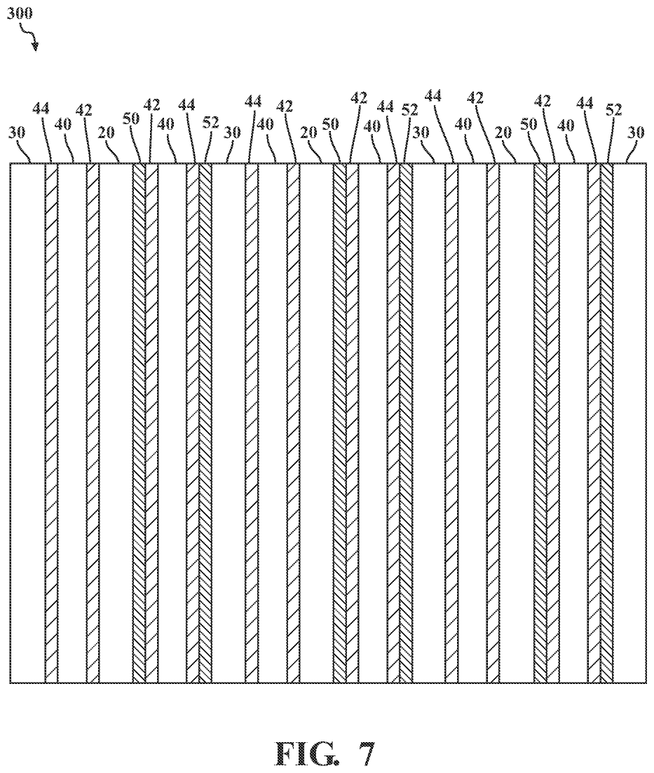

The embodiments of the lithium-ion battery 10 of FIGS. 2-4 may be utilized within a battery system including alternating layers of anodes 20 and cathodes 30, each separated by a separator 40. FIG. 7 illustrates an exemplary battery system 300 including an alternating stack of the anodes 20 and the cathodes 30, wherein the separators 40 including the layers of porous ceramic material 42 and 44 are illustrated disposed between each of the electrodes and wherein a portion 302 includes every other separator 40 includes layers of lithium 50 and 52 disposed on both sides of the separator 40. One may say that a remaining portion 304 of the separators 40 that do not include layers of lithium are lithium-layer-free. In this configuration, like the case of single side coating illustrated in FIGS. 2 and 3, lithium from the layers of lithium 52 facing one of the cathodes 30 travel through the respective separator 40 to reach the respective anode 20 which has no lithium layer facing that anode 20 to complete pre-lithiation. In one embodiment of the battery system 300 of FIG. 7, the outer two most electrodes may be the anodes 20, in which case both of the anodes 20 would include a facing lithium layer, one of the layers of lithium 50, in contact with the anodes 20.

In the embodiment of FIG. 7, the outer two most electrodes illustrated are the cathodes 30. The layer of lithium 52 facing the cathode 30 at a right side of the illustration has no anode 20 to which to provide lithium ions. In one embodiment, the respective separator 40 may instead have layer of lithium 50 and omit layer of lithium 52. In another embodiment, the separator 40 adjacent to the cathode 30 at the right side of the illustration may include the illustrated layer of lithium 52. Maintaining the single separator configuration in the battery system 300 reduces manufacturing complexity by eliminating multiple types of separators 40 in the battery system 300, and the respective layer of lithium 52 may provide an additional lithium source or lithium with the battery system 300 for excellent battery lifespan.

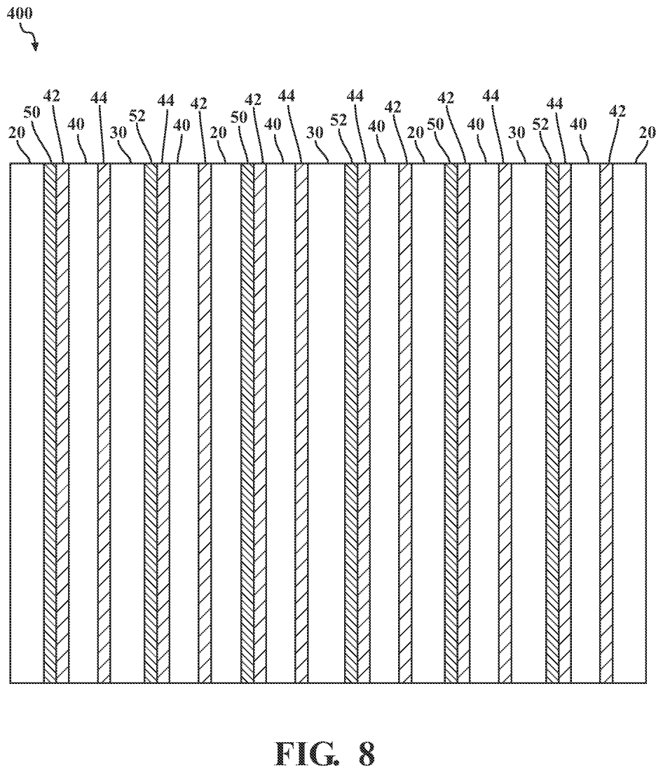

FIG. 8 illustrates an alternative battery system 400 including an alternating stack of anodes 20 and cathodes 30, wherein separators 40 including the layers of porous ceramic material 42 and 44 are illustrated disposed between each of the electrodes and wherein every separator 40 has a single layer of lithium 50 or 52 disposed facing a same side of the battery system 400. The layers of lithium 50 and 52 alternatively face toward one of the anodes 20 or face toward one of the cathodes 30. Layers of lithium 50 directly lithiate the respective anodes 20 adjacent thereto, while the layers of lithium 52 provide lithium ions that travel across the respective separator 40 to lithiate the respective anode 20 which has no lithium layer facing to it. The layers of lithium 52 may be fast formed with a thickness of a few microns and may be manufactured with significantly low cost. In one embodiment, a common separator 40 with one side of the separators 40 coated with a thin layer of lithium may be capable of being utilized as the layer of lithium 50 or the layer of lithium 52, with the separator being versatile and capable of providing either layer of lithium 50 or 52 depending upon assembly order of the battery system 400.

While the best modes for carrying out the disclosure have been described in detail, those familiar with the art to which this disclosure relates will recognize various alternative designs and embodiments for practicing the disclosure within the scope of the appended claim

What is claimed is:

1. A system including a lithium-ion battery, the system comprising:
two electrodes including:
an anode; and
a cathode;
an electrolyte; and
a planar separator disposed between the anode and the cathode and including:
a first planar face;
a second planar face;
a layer of porous ceramic material coating the first planar face; and
lithium deposited upon the layer of porous ceramic material, wherein the lithium is in contact with one of the two electrodes.

2. The system of claim 1, wherein the layer of porous ceramic material includes a first layer of porous ceramic material; and
wherein the planar separator further includes a second layer of porous ceramic material coating the second planar face.

3. The system of claim 2, wherein the first layer of porous ceramic material is formed from a first material selected from the group consisting of zeolite, alumina, silica, titania, zirconia, and combinations thereof; and
wherein the second layer of porous ceramic material formed from a second material selected from the group consisting of zeolite, alumina, silica, titania, zirconia, and combinations thereof.

4. The system of claim 2, wherein the lithium deposited upon the layer of porous ceramic material is a first layer of lithium; and
wherein the planar separator further includes a second layer of lithium deposited upon the second layer of porous ceramic material.

5. The system of claim 1, wherein the layer of porous ceramic material is formed from a material selected from the group consisting of zeolite, alumina, silica, titania, zirconia, and combinations thereof.

6. The system of claim 1, wherein the lithium deposited upon the layer of porous ceramic material is a layer of lithium.

7. The system of claim 1, wherein the lithium is in contact with the anode.

8. The system of claim 1, wherein the lithium is in contact with the cathode.

9. A system comprising:
a device including a lithium-ion battery, the lithium-ion battery including:
two electrodes including:
an anode; and
a cathode;
an electrolyte; and
a planar separator disposed between the anode and the cathode and including:
a first planar face;
a second planar face;
a layer of porous ceramic material coating the first planar face; and
lithium deposited upon the layer of porous ceramic material, wherein the lithium is in contact with one of the two electrodes.

10. The system of claim 9, wherein the device includes a vehicle.

11. The system of claim 9, wherein the layer of porous ceramic material includes a first layer of porous ceramic material; and
wherein the planar separator further includes a second layer of porous ceramic material coating the second planar face.

12. The system of claim 11, wherein the first layer of porous ceramic material is formed from a first material selected from the group consisting of zeolite, alumina, silica, titania, zirconia, and combinations thereof; and
wherein the second layer of porous ceramic material formed from a second material selected from the group consisting of zeolite, alumina, silica, titania, zirconia, and combinations thereof.

13. The system of claim 9, wherein the layer of porous ceramic material is formed from a material selected from a group consisting of zeolite, alumina, silica, titania, zirconia, and combinations thereof.

14. The system of claim 9, wherein the lithium deposited upon the layer of porous ceramic material is a layer of lithium.

15. The system of claim 9, wherein the lithium is in contact with the anode.

16. The system of claim 9, wherein the lithium is in contact with the cathode.

17. A lithium-ion battery system comprising:
an alternating electrode pattern including a plurality of anodes and a plurality of cathodes;
an electrolyte; and
a plurality of planar separators each disposed between each of the plurality of anodes and each of the plurality of cathodes, each of the plurality of planar separators including:
a first planar face;
a second planar face;
a first layer of porous ceramic material coating the first planar face; and
a second layer of porous ceramic material coating the second planar face;
wherein each of a portion of the plurality of planar separators further includes a layer of lithium deposited upon the first layer of porous ceramic material, wherein the layer of lithium is in contact with one of the plurality of anodes and one of the plurality of cathodes.

18. The lithium-ion battery system of claim 17, wherein each of the plurality of planar separators further includes the layer of lithium deposited upon the first layer of porous material.

19. The lithium-ion battery system of claim 17, wherein the layer of lithium includes a first layer of lithium; and
wherein each of the portion of the plurality of planar separators further includes a second layer of lithium deposited upon the second layer of porous ceramic material.

20. The lithium-ion battery system of claim 19, wherein each of a remaining portion of the plurality of planar separators is lithium-layer-free; and
wherein the portion of the planar separators and the remaining portion of the planar separators form an alternating pattern within the lithium-ion battery system.
